(19) United States
(12) Patent Application Publication
(10) Pub. No.: US 2009/0214417 A1
(43) Pub. Date: Aug. 27, 2009

(54) PREPARATION OF COBALT-BORON ALLOY CATALYSTS USEFUL FOR GENERATING HYDROGEN FROM BOROHYDRIDES

(75) Inventors: Ajay K. Prasad, Newark, DE (US); Suresh G. Advani, Newark, DE (US); Krishnan Palanichamy, Newark, DE (US)

Correspondence Address: RATNERPRESTIA, P.O. BOX 1596, WILMINGTON, DE, 19899, US

(73) Assignee: University of Delaware, Newark, DE (US)

(21) Appl. No.: 12/344,316

(22) Filed: Dec. 26, 2008

Related U.S. Application Data
(60) Provisional application No. 61/009,135, filed on Dec. 26, 2007.

(51) Int. Cl. C01B 3/08; C22C 1/00; C22C 19/07; B01J 21/02; C01B 3/02

(52) U.S. Cl. 423/657; 75/392; 75/710; 420/591; 420/435; 502/207; 423/648.1

(57) ABSTRACT

A method of making a cobalt-boron alloy includes contacting an aqueous suspension of an oxide of cobalt, particularly a highly crystalline cobalt oxide, with a borohydride such as sodium borohydride. The resulting alloy may be used as a catalyst to produce gaseous hydrogen by hydrolysis of aqueous sodium borohydride.

### CROSS-REFERENCE TO RELATED APPLICATIONS

This application claims priority from U.S. provisional application 61/009,135, filed Dec. 26, 2007, and incorporated herein by reference in its entirety for all purposes.

### STATEMENT REGARDING FEDERALLY SPONSORED RESEARCH

The U.S. Government has a paid-up license in this invention and the right in limited circumstances to require the patent owner to license others on reasonable terms as provided for by the terms of Contract No. JPP-05-DE-03-7001, awarded by the Federal Transit Administration.

### BACKGROUND OF THE INVENTION

Hydrogen is a fuel with significant potential for use as an energy source in a variety of commercial applications. For example, Polymer Electrolyte Membrane Fuel Cells (PEMFCs) are being developed as pollution-free power sources for transportation, residential and portable applications. In a H₂/O₂ PEMFC, chemical energy stored in H₂ is converted into electrical energy in the presence of a catalyst (typically Pt/C) and a proton-conducting polymer electrolyte membrane. However, commercialization of PEMFC technology has been difficult due to challenges encountered in establishing the H₂ supply infrastructure. Typically, H₂ is stored in pressurized cylinders due to the low volumetric energy density of gaseous H₂. In addition to safety concerns, high-pressure H₂ tanks have very low gravimetric and volumetric storage efficiencies. Moreover, adequate materials technologies for high-pressure storage are yet to be advanced. On the other hand, chemical hydrides have good gravimetric storage capacity and their alkaline solutions are relatively safe for transportation. Among the chemical hydrides, sodium borohydride (NaBH₄) is desirable due to its high H₂ content of 10.57 wt % and the excellent stability of its alkaline solutions. Aqueous solutions of NaBH₄ undergo hydrolysis in the presence of suitable catalysts to produce H₂, essentially free from impurities. However, many catalysts for such hydrolysis are based on expensive precious metals such as Pt and Ru, and catalysts based on less expensive metals would be of significant commercial utility.

### SUMMARY OF THE INVENTION

In one aspect, the invention provides a method of making a cobalt-boron alloy, comprising contacting an oxide of cobalt, which may be in the form of an aqueous suspension, with a borohydride such as sodium borohydride.

In another aspect, the invention provides a cobalt-boron alloy prepared by the method described immediately above.

In still another aspect, the invention provides a method of producing hydrogen, comprising contacting the cobalt-boron alloy described immediately above with a borohydride such as aqueous sodium borohydride.

### BRIEF DESCRIPTION OF THE DRAWINGS

FIG. 1 is a schematic diagram of a process for preparing Co—B alloy catalysts according to the invention.

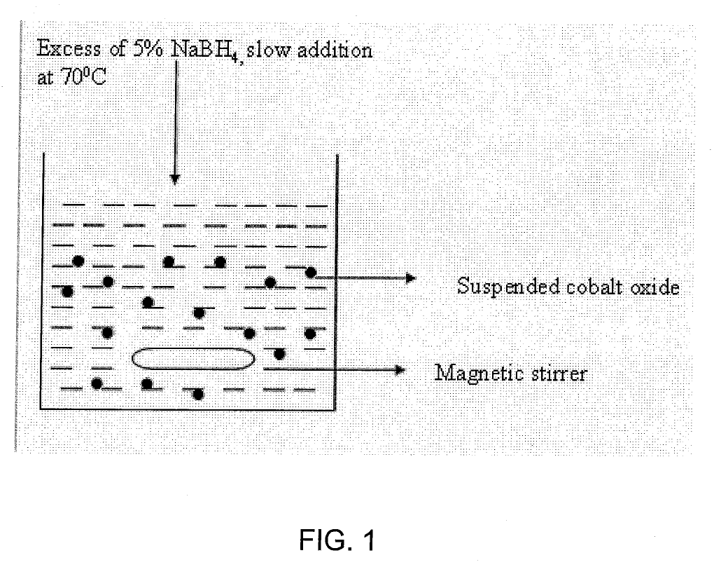

FIG. 2 is a schematic diagram of a method of producing H₂ from alkaline-stabilized NaBH₄ using a Co—B catalyst for use in a PEMFC according to the invention.

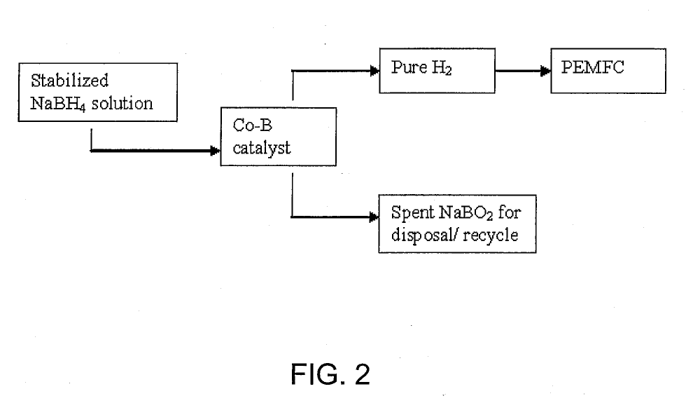

FIG. 3 shows a powder X-ray diffraction pattern of LiCoO₂.

FIG. 4 shows a powder X-ray diffraction pattern of Co—B prepared from LiCoO₂ according to the invention (Example 1).

FIG. 5 shows the hydrogen gas generation profile of Co—B prepared from LiCoO₂ (5 wt % NaBH₄ in 5 wt % NaOH) according to the invention (Example 1).

### DETAILED DESCRIPTION OF CERTAIN EMBODIMENTS OF THE INVENTION

For many cobalt-based catalysts that are intended to be used in the hydrolysis of borohydrides and the like, there is a substantial time delay for H₂ generation. It has now been found that this can be avoided by preparing a cobalt-boron alloy catalyst by reacting an oxide of cobalt with a borohydride such as aqueous sodium borohydride. The use of these oxides as precursors allows the preparation of inexpensive Co—B alloy catalysts which could replace the expensive Pt and Ru based catalysts for H₂ generation from NaBH₄. The cobalt oxides undergo chemical reduction in the presence of borohydride compounds such as NaBH₄ to generate catalytically active Co—B compounds. The Co—B alloy catalysts that are obtained are believed to be comprised of cobalt borides such as CO₂B, which is considered to be a particularly active species for catalyzing the decomposition of borohydrides to yield hydrogen, although other species such as Co(s) metal and Co(BO₂)₂ may also be present depending upon the precise conditions selected for the cobalt oxide/borohydride reaction. Preferably, the cobalt-boron alloy catalyst is essentially free or free of any transition metals such as platinum and ruthenium and/or is substantially or entirely amorphous (non-crystalline). The Co—B compounds can either be prepared in-situ in the H₂ generation reactor or they can be prepared ex-situ and added to the H₂ generation reactor. The in-situ catalyst preparation may involve some time delay for H₂ generation, depending on the reactivity of the oxide material for the Co—B alloy formation, but in some situations this may not be a problem and may afford the convenience of avoiding a separate catalyst preparation step. Alternatively, it has been found that one can prepare the active Co—B compound outside of the H₂ generator so that H₂ generation could occur immediately on contacting the catalyst with borohydride in the H₂ generation reactor.

Co—B alloys are prepared according to the invention from oxides of cobalt such as cobalt (II,III) oxide (CO₃O₄), CoO and CO₂O₃, as well as alkali metal cobalt oxides such as those corresponding to the formula MCoO₂ where M is an alkali metal (e.g., lithium cobalt oxide, LiCoO₂). Suitable oxides of cobalt may comprise Co²⁺ and/or Co³⁺ and may comprise mixtures of two or more different cobalt oxides. These materials are commercially available in large volumes, and they could be an attractive source for the preparation of cobalt-boron alloy catalysts.

It has been unexpectedly discovered that the catalytic activity of the cobalt-boron alloy obtained by reaction of cobalt oxide with borohydride is influenced by the crystallinity of the starting cobalt oxide, particularly where the cobalt oxide is CO₃O₄. That is, as the crystallinity of the cobalt oxide increases, the cobalt-boron alloy obtained therefrom can exhibit increased efficiency in catalyzing the generation of hydrogen from a borohydride. Without wishing to be bound by theory, it is believed that the catalytic activity of the cobalt-boron alloy is substantially due to the presence of cobalt boride (CO₂B) in the alloy. During reduction of the cobalt oxide with the borohydride, species other than cobalt boride such as CoB₂ and Co(s) metal having lower catalytic activity may also be formed as a result of competing side reactions. It is believed that more highly crystalline cobalt oxides react faster with the borohydride, thereby improving the yield of cobalt boride. The crystallinity of the cobalt oxide may be readily determined by conventional methods such as powder x-ray diffraction (XRD) techniques. The method utilized for preparing the cobalt oxide can be varied to improve the degree of crystallinity. For example, when preparing a cobalt oxide by thermal decomposition of a cobalt compound such as cobalt nitrate in the presence of oxygen, the decomposition temperature selected can influence the product crystallinity. Generally speaking, higher decomposition temperatures will lead to more crystalline cobalt oxides, at least up to a certain temperature. For example, when cobalt nitrate is decomposed in air, decomposition temperatures of 350 to 700 degrees C. have been found to yield more crystalline cobalt oxides than lower decomposition temperatures (e.g., 200 degrees C.).

The borohydride which is reacted with the cobalt oxide may be a borohydride containing any suitable cation such as a metal borohydride (e.g., lithium borohydride, sodium borohydride, potassium borohydride), tetraalkyl ammonium borohydride or ammonium borohydride. Sodium borohydride is particularly preferred. It will generally be desirable to use a stoichiometric excess of the borohydride relative to the cobalt oxide, to ensure complete reduction of the cobalt oxide.

The reaction of the borohydride with the cobalt oxide is typically carried out in the presence of a proton donor solvent such as water and/or alcohol, with the cobalt oxide being in the form of a powder suspended in the solvent with the borohydride. The borohydride (dissolved in the solvent) typically is added with stirring to the cobalt oxide suspension either continuously or in portions. To accelerate the desired reaction of the borohydride and cobalt oxide, it may be preferable to carry out the contacting at a somewhat elevated temperature (e.g., 50 degrees C. to 90 degrees C.), depending upon the reactivities of the starting materials selected. For certain starting materials, however, the reaction proceeds relatively rapidly even at room temperature (e.g., 15 to 30 degrees C.). The cobalt-boron alloy catalyst will generally remain as a solid phase in the solvent, e.g., in the form of suspended particles.

If desired, the cobalt-boron alloy catalyst thereby obtained may be isolated by a suitable separation method such as filtration. The separated catalyst may thereafter be subjected to further processing steps such as, for example, washing (typically, with fresh portions of solvent) and/or drying. The catalyst can then be introduced in a desired quantity into a reactor or other vessel and utilized to catalyze the decomposition of a borohydride to generate hydrogen gas.

Alternatively, the reaction of the cobalt oxide and borohydride may be carried out directly in the reactor which is to be subsequently used for hydrogen generation (i.e., the cobalt-boron alloy catalyst may be formed in situ, without being first isolated).

There are numerous potential applications for the methods and catalyst of this invention. For example, difficulties involved in setting up steam reformation units for H₂ production, purification, storage and transportation could be circumvented by adopting NaBH₄ based H₂ generators. This is an enabling technology for faster commercialization of PEMFCs. Pure H₂ could be prepared on demand without any safety issues which could enhance the life of PEMFCs. The inexpensive Co—B based catalysts proposed in the invention will substantially reduce the overall cost of NaBH₄ based H₂ generation systems so that they could be easily adopted for common applications.

The present invention thus also may include a process of hydrogen generation using the cobalt-boron alloy catalyst prepared in accordance with the methods described herein, said process comprising contacting the catalyst with a borohydride. Preferably the borohydride is in a solution comprising a proton donor solvent such as water and/or alcohol. A base may also be present in the solution to help stabilize the borohydride. The borohydride may be a borohydride containing any suitable cation such as a metal borohydride (e.g., lithium borohydride, sodium borohydride, potassium borohydride), tetraalkyl ammonium borohydride or ammonium borohydride. Generally, it will be advantageous to employ aqueous solutions containing about 5 to about 20 weight % borohydride, with sodium borohydride being particularly preferred. Suitable bases include alkali metal hydroxides (lithium hydroxide, sodium hydroxide, potassium hydroxide), sodium sulfide, sodium zincate, sodium gallate, sodium silicate as well as mixtures thereof. Cobalt-boron alloy catalysts prepared in accordance with the present invention typically exhibit good activity at around room temperature such that heating of the reaction components often is not necessary in order to attain satisfactory rates of reaction. However, if desired, the contacting of the catalyst with the borohydride may be carried out at an elevated temperatures. Reaction temperatures of from about 10 to 90 degrees C. typically are effective. The catalyst may be suspended in the form of particles in a liquid medium containing the borohydride within a suitable reaction vessel, with stirring being carried out to ensure good mixing. Alternatively, the catalyst may be deployed in fixed or supported form, with the liquid medium containing the borohydride being circulated through or passed over the catalyst so as to contact the catalyst with the borohydride. The hydrogen which is evolved from the catalyzed decomposition of the borohydride may be withdrawn from the reaction vessel in the form of a gas. Any of the methodologies, techniques, or equipment known in the art for carrying out the decomposition of borohydride using a heterogeneous catalyst may be readily adapted for use with the cobalt-boron alloy catalysts prepared in accordance with the present invention.

### EXAMPLES

### Example 1

### Experimental Procedure for the Preparation of a Co—B Alloy Catalyst from LiCoO₂

In a 250 mL beaker containing 50 mL of de-mineralized (DM) water, suspend 2.0 g of LiCoO₂ powder. Heat the suspension to 60° C. over a hot plate under magnetic stirring. Then, slowly add 5.0 wt. % NaBH₄ solution in small aliquots with continuous stirring. Initially NaBH₄ will be utilized for the formation of Co—B. Evolution of H₂ becomes vigorous once Co—B is formed in sufficient quantity from the oxide. Add excess of NaBH₄ (approximately 50 mL) to ensure complete reduction of LiCoO₂. Cool the suspension to room temperature and filter using a Buchner funnel over Whatmann 40 filter paper. Wash the precipitate collected by filtration thoroughly with DM water. Dry the Co—B overnight in a convection oven at 110° C.

### Characterization of the Catalyst by Powder X-Ray Diffraction (XRD)

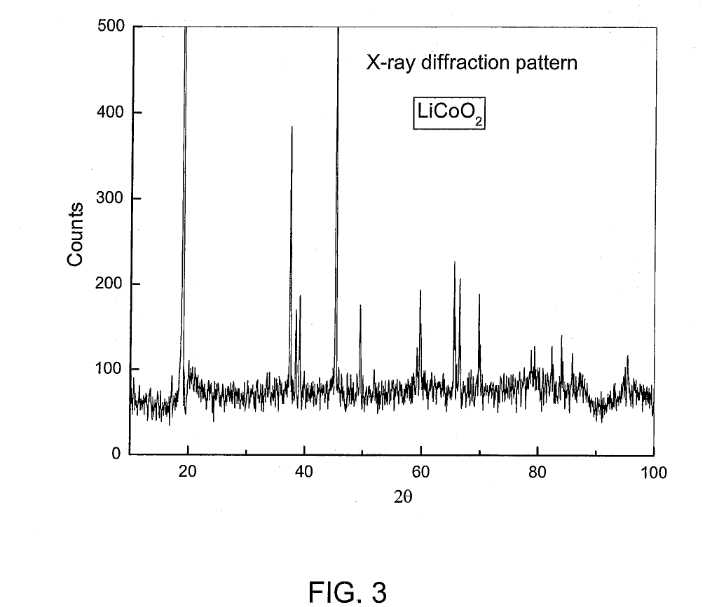

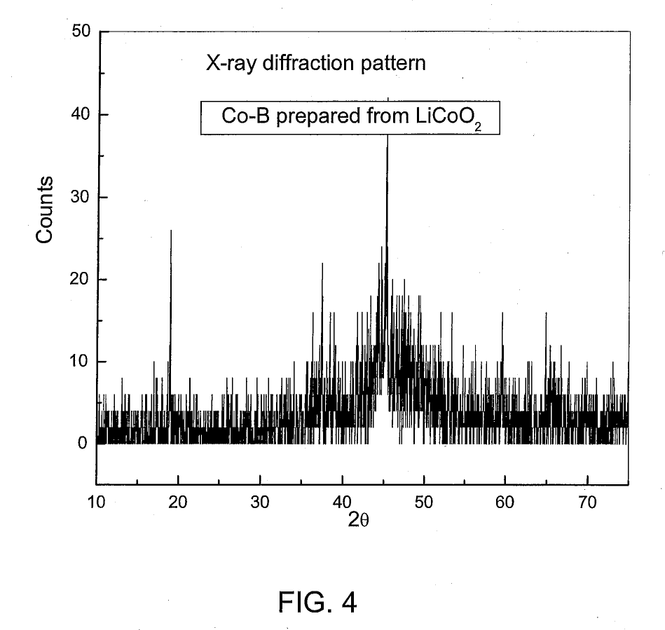

The powder XRD patterns of the LiCoO₂ and the Co—B catalyst prepared from LiCoO₂ were recorded in the 2θ range 10°-80° with a RIGAKU D/MAX-IIIC diffractometer using Cu Ka (λ=1.4518 A°) radiation filtered through Ni. The powder XRD pattern of LiCoO₂ is shown in FIG. 3. The X-ray diffraction pattern of commercial LiCoO₂ exactly matches with the hexagonal crystal system reported in the literature (Oh, S. H., Jeong, W. T., Cho, W. I., Cho, B. W., Woo, K., J. Alloys Compd. 2005, 391, 296-301). The X-ray diffraction of the Co—B alloy catalyst (FIG. 4) shows very weak diffraction peaks and the diffraction pattern of LiCoO₂ is absent, thus establishing the amorphous nature of the reaction product.

### Generation of H₂

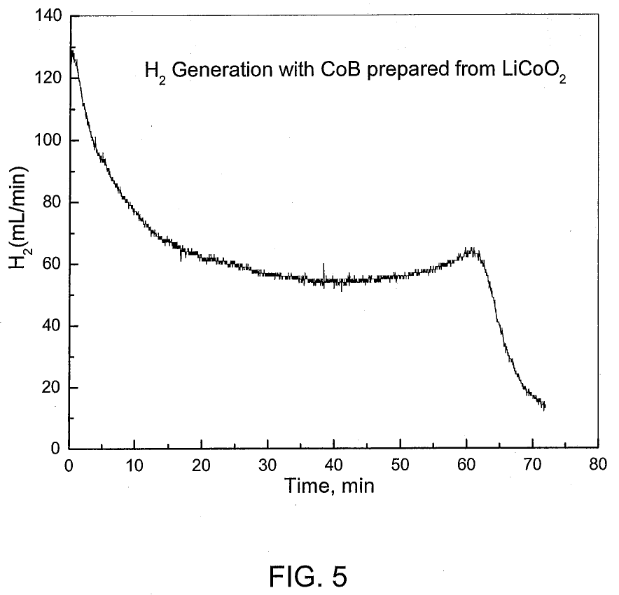

In a typical H₂ generation experiment, 25 mL of NaBH₄ solution was placed in a thermostated tubular glass vessel. Exactly 50 mg of Co—B catalyst was added, and the H₂ flow was measured using a mass flow meter whose output was continuously recorded by a computer. Temperature of the hydrolysis solution was maintained at 25° C. The H₂ generation profile of a typical experiment is given in FIG. 5. The H₂ generation rate is high from the very start and reaches a steady value and maintains this value until all of the NaBH₄ is hydrolyzed. Once all of the NaBH₄ is hydrolyzed, the H₂ generation drops off.

### Example 2

Cobalt oxide (CO₃O₄) was prepared by the thermal decomposition of Co(NO₃)₂ (cobalt (II) nitrate hexahydrate, obtained from Across Organics) under flowing air in a tubular furnace at 200, 400, and 600 degrees C. The crystallinity of the cobalt oxide obtained, as measured by powder XRD analysis, increased at higher decomposition temperatures (the intensity of the diffraction peaks increased and the peak width decreased with an increase in the cobalt oxide preparation temperature).

### Example 3

Cobalt-boron alloy catalysts were prepared in situ in a H₂ generation reactor by suspending either CO₃O₄ or LiCoO₂ in demineralized water at room temperature and adding stabilized sodium borohydride solution under continuous stirring. With both of these oxides, a slow formation of the cobalt-boron alloy catalyst was indicated by the substantial time delay before hydrogen evolution commenced. However, the delay time could be reduced by increasing the temperature at which the oxide was contacted with the sodium borohydride.

### Example 4

Cobalt-boron alloy catalysts were also prepared externally (i.e., outside of a H₂ generation reactor) from both LiCoO₂, a commercially obtained sample of CO₃O₄, and a sample of CO₃O₄ prepared at 600 degrees C. in accordance with Example 2. Since the CO₃O₄ reacted with sodium borohydride at a very slow rate at room temperature, a preparation temperature of 70 degrees was employed. The preparation temperature using the LiCoO₂ was room temperature. An excess of sodium borohydride solution was added to the LiCoO₂ and CO₃O₄ and the resulting cobalt-boron alloy catalysts that were formed were isolated by filtering under vacuum, rinsing with demineralized water, and drying under vacuum at 110 degrees C. The catalysts were dissolved by microwave-assisted acid digestion and analyzed by inductively coupled plasma (ICP) for their Co and B content (Table 1).

TABLE 1

| | | | Co₂B, wt. % |
|---|---|---|---|
| Catalyst Precursor | Co, wt. % | B, wt. % | (calculated) |
| LiCoO₂ | 81.53 | 2.74 | 32.63 |
| Co₃O₄ | 68.70 | 1.37 | 16.34 |
| (commercial) | | | |
| Co₃O₄ | 84.40 | 4.93 | 58.60 |
| (600 degrees C.) | | | |

### Example 5

In a typical hydrogen generation experiment, 25 mL of sodium borohydride solution was placed in a thermostated tubular glass vessel maintained at 25 degrees C. A known weight of catalyst (or catalyst precursor, where the catalyst was to be formed in situ) was added and the generated H₂ was measured using a mass flow meter whose output was continuously recorded by a computer. The suitability of the cobalt-boron alloy catalysts for extended operation was studied in a 1000 mL capacity tubular reactor. About 700 g of NaBH₄ solution (varying in sodium borohydride content from 5 to 20 weight %, stabilized with 5 wt. % NaOH) was placed in the reactor and the experiment was continued until all the NaBH₄ in the solution was hydrolyzed.

### Example 6

When a commercially purchased CO₃O₄ (Aldrich) was used as the precursor (50 mg) to prepare a cobalt-boron alloy catalyst in situ in accordance with the procedures of Example 3, the H₂ generation rate was negligible at 25 degrees C. when the catalyst was used in a hydrogen generation experiment in accordance with Example 5. The H₂ generation rate was around 5 mL/min for the duration of the experiment (45 min) using 5 weight % sodium borohydride. The H₂ generation rate increased continuously to reach 12 mL/min at the end of 45 minutes using 10 weight % sodium borohydride. The generation rate decreased slightly when the NaBH₄ concentration was further increased to 20 weight %. The low H₂ generation rates suggest that catalytically active cobalt-boron alloy was not formed in significant quantities under these experimental conditions.

### Example 7

In this example, a cobalt-boron alloy prepared in situ from LiCoO₂ (50 mg) in accordance with Example 3 was used as the catalyst to decompose sodium borohydride to form hydrogen (reaction temperature=25 degrees C.) in accordance with the procedures of Example 5. Using 5 weight % NaBH₄, H₂ generation was insignificant for the first 10 minutes after which it increased to reach a steady value of 130 mL/min over the next 20 minutes. The rapid increase in hydrogen generation after a delayed start indicates the time required to form an active cobalt-boron alloy catalyst from the LiCoO₂ precursor. Using 10 weight % sodium borohydride, H₂ generation initiated in 2 minutes and the rate reached a steady value of 210 mL/min in 15 minutes. As the formation of the cobalt-boron alloy from LiCoO₂ depends upon the concentration of borohydride, increasing the concentration of NaBH₄ from 50 to 10 weight % is believed to lead to faster and more efficient CO₂B formation and thus a higher H₂ generation rate. Further increasing the sodium borohydride concentration to 20 weight % also yielded H₂ generation within 2 minutes as with 10 weight % sodium borohydride, however the maximum rate of 130 mL/min obtained was lower. It is believed this could be due to the enhanced stability of 20 weight % NaBH₄ solution owing to its higher alkalinity.

### Example 8

Carbon-boron alloy catalysts (50 mg) prepared externally (ex situ) from LiCoO₂ and commercially obtained CO₃O₄ in accordance with the procedures of Example 4 were used in H₂ generation experiments in accordance with Example 5. In both cases, instantaneous H₂ generation was observed (i.e., hydrogen generation was not delayed). The H₂ generation rate observed when the catalyst was externally prepared from CO₃O₄ at 70 degrees C. was better than when the catalyst was prepared in situ from the same starting material, although such rate was still lower than would be desirable in practical applications. At a sodium borohydride concentration of 5 weight %, the maximum H₂ generation rate observed for the catalyst prepared externally from LiCoO₂ was almost the same as that observed for the catalyst prepared in situ from LiCoO₂.

### Example 9

Cobalt-boron alloy catalysts were prepared in situ in accordance with the procedures of Example 3, using CO₃O₄ samples prepared at different decomposition temperatures in accordance with Example 2, and evaluated in hydrogen generation experiments in accordance with the procedures of Example 5 (50 mg precursor, 25 degrees C., 20 weight % NaBH₄). The H₂ generation profiles of the in situ generated catalysts were found to be highly dependent upon the temperature at which the CO₃O₄ precursor was prepared. When CO₃O₄ prepared at 200 degrees C. was used as the catalyst precursor, H₂ generation initiated only after a long delay of 50 minutes. The rate increased slowly after 50 minutes and reached a value of 60 mL/min after 100 minutes. About 300 minutes was required to hydrolyze all the sodium borohydride present in 25 mL of 20 weight % sodium borohydride solution. The delay time decreased substantially when CO₃O₄ prepared at 400 degrees C. was used as the catalyst precursor. Hydrogen generation initiated after 30 minutes and reached a value of 150 mL/min in 40 minutes. All the NaBH₄ present in 25 mL of 20 weight % sodium borohydride solution was hydrolyzed in 150 minutes. When CO₃O₄ prepared at 600 degrees C. was used as the catalyst precursor, hydrogen generation initiated within 5 minutes and attained a rate of 425 mL/min in 10 minutes. All of the sodium borohydride present was hydrolyzed within 75 minutes.

Although the invention is illustrated and described herein with reference to specific embodiments, the invention is not intended to be limited to the details shown. Rather, various modifications may be made in the details within the scope and range of equivalents of the claims and without departing from the invention.

What is claimed is:

1. A method of making a cobalt-boron alloy, comprising contacting an oxide of cobalt with a borohydride.

2. The method of claim 1, wherein the oxide of cobalt is selected from the group consisting of CoO, CO₂O₃, CO₃O₄ and MCoO₂, wherein M is an alkali metal, and mixtures thereof.

3. The method of claim 1, wherein the borohydride is selected from the group consisting of lithium borohydride, sodium borohydride, potassium borohydride, ammonium borohydride, tetraalkyl ammonium borohydrides, and mixtures thereof.

4. The method of claim 1, wherein said oxide of cobalt is in the form of a suspension in a liquid medium during said contacting.

5. The method of claim 1, wherein said oxide of cobalt is in the form of particles suspended in an aqueous medium during said contacting.

6. The method of claim 1, wherein said oxide of cobalt has been prepared by thermal decomposition of Co(NO₃)₂ in air at a temperature of from about 350 to about 700 degrees C.

7. The method of claim 1, wherein said oxide of cobalt is crystalline.

8. The method of claim 1, wherein said cobalt-boron alloy is comprised of CO₂B.

9. The method of claim 1, wherein said cobalt-boron alloy is comprised of at least 50 weight % CO₂B.

10. The method of claim 1, wherein said contacting is carried out in the presence of a proton donor solvent.

11. The method of claim 1, wherein an excess of borohydride is used relative to the oxide of cobalt.

12. The method of claim 1, wherein said contacting is carried out at a temperature of from about 50 to about 90 degrees C.

13. The method of claim 1, wherein said oxide of cobalt is in the form of particles suspended in an aqueous medium during said contacting and the cobalt-boron alloy produced is collected by filtration and dried.

14. The method of claim 1, wherein said oxide of cobalt is crystalline CO₃O₄.

15. The method of claim 1, wherein said cobalt-boron alloy is substantially or entirely amorphous.

16. A method of making a catalyst useful for catalyzing the formation of H₂ from a borohydride, said method comprising contacting an aqueous suspension of crystalline particles of CO₃O₄ or LiCoO₂ with an excess of sodium borohydride under conditions effective to reduce the CO₃O₄ or LiCoO₂ to form substantially or entirely amorphous particles of a cobalt-boron alloy comprised of at least 50 weight percent CO₂B.

17. A method of producing hydrogen, comprising contacting a cobalt-boron alloy obtained by the method of claim 1 with a borohydride.

18. The method of claim 17, wherein said contacting is carried out in an aqueous medium having a sodium borohydride content of from 5 to 20 weight %.

19. A cobalt-boron alloy prepared according to the method of claim 1.
